(19) United States
(12) Patent Application Publication
(10) Pub. No.: US 2026/0366598 A1
(43) Pub. Date: Nov. 19, 2026

(54) SPEED REDUCER AND CONSTRUCTION MACHINE

(71) Applicant: NABTESCO CORPORATION, Tokyo (JP)

(72) Inventors: Masato UCHIHARA, Tokyo (JP); Yuta WANAKA, Tokyo (JP)

(21) Appl. No.: 19/135,263

(22) PCT Filed: Sep. 19, 2023
(86) PCT No.: PCT/JP2023/033967

§ 371 Date: Jun. 3, 2025

(30) Foreign Application Priority Data
Dec. 5, 2022 (JP) 2022-194481

(51) Int. Cl. F16H 1/32; E02F 9/20

(52) U.S. Cl. CPC F16H 1/32; E02F 9/202; F16H 2001/323

(57) ABSTRACT

[Problem] It is desired to mitigate impacts transmitted to a speed reducer.

[Solution] The speed reducer includes: a speed reducing unit configured to reduce rotation input thereto; a first member having a housing portion housing the speed reducing unit, the first member having a through hole used to fixedly attach the housing portion to a mounting member; and a tubular buffer portion covering an inner wall of the through hole, the buffer portion having a first portion and a second portion with different degrees of deformability under a certain level of stress.

### TECHNICAL FIELD

The present invention relates to a speed reducer, and a construction machine.

### BACKGROUND ART

In the conventional art, there is a known device that can produce propulsion through rotation output from an electric motor. For example, Patent Document 1 discloses an electric linear actuator for generating propulsion, for use in a construction machine such as an excavator. More specifically, Patent Document 1 discloses that the electric linear actuator can be used to drive a boom, an arm, a bucket of an excavator.

In addition, there is a known technology of mitigating impacts on a device that can produce propulsion through rotation output from an electric motor. For example, Patent Document 1 discloses an impact mitigation device formed by a spring or other elastic member, which can mitigate impact forces applied to the piston of the electric linear actuator.

### CITATION LIST

### Patent Document

Patent Document 1: International Publication No. WO 2013/114451

### SUMMARY OF INVENTION

The device that can produce propulsion through rotation output from an electric motor may have a built-in speed reducer for reducing the rotation of the electric motor. In such cases, impacts may be transmitted to the speed reducer. More specifically, the device having the built-in speed reducer may be used to drive construction machines such as the boom, arm, and bucket of an excavator. In this case, the speed reducer may be subjected to relatively large impacts. The speed reducer may be partly damaged if an intense impact is transmitted to any part of the speed reducer, for example, a part that is configured to reduce the rotation input into the speed reducer. Therefore, there is a need to mitigate the impact transmitted to the speed reducer, more specifically, part of the speed reducer.

The present invention has been made in view of such circumstances, and an object of the invention is to mitigate impacts transmitted to a speed reducer.

A first aspect of the present disclosure provides a speed reducer including: a speed reducing unit configured to reduce rotation input thereto; a first member having a housing portion housing the speed reducing unit, the first member having a through hole used to fixedly attach the housing portion to a mounting member; and a tubular buffer portion covering an inner wall of the through hole, the buffer portion having a first portion and a second portion with different degrees of deformability under a certain level of stress.

According to a second aspect of the present disclosure, the speed reducer of the first aspect described above may further include a tubular bushing, the bushing being provided inside the buffer portion.

According to a third aspect of the present disclosure, in the speed reducer of the second aspect described above, a dimension of the bushing in an axial direction in which the through hole extends may be greater than that of the through hole in the axial direction.

According to a fourth aspect of the present disclosure, in the speed reducer of the second or third aspect described above, the first member may further include a flange portion protruding from the housing portion in a direction intersecting an axial direction in which the through hole extends, the flange portion facing the mounting member. The flange portion may have the through hole, and a dimension of the bushing in the axial direction may be greater than that of the flange portion in the axial direction.

According to a fifth aspect of the present disclosure, the speed reducer of each one of the second to fourth aspects described above may further include a bolt passing through the bushing to fixedly attach the housing portion to the mounting member. A dimension of the bushing in a radial direction perpendicular to an axis of the through hole may be equal to or greater than a dimension of a head of the bolt in the radial direction.

According to a sixth aspect of the present disclosure, the speed reducer of each one of the first to fifth aspects described above may further include a second member rotatable relative to the first member. The first member may have internal teeth, and the speed reducing unit may have: a crankshaft rotatably supported by the second member; and an external gear having a through hole penetrated by the crankshaft, the external gear having external teeth meshing with the internal teeth of the first member.

According to a seventh aspect of the present disclosure, the speed reducer of each of the second to fifth aspects described above may further include the mounting member arranged next to the first member with a gap in a radial direction perpendicular to an axis of the through hole; and a bolt passing through the bushing to fixedly attach the housing portion to the mounting member. A width of the gap between the first member and the mounting member in the radial direction may be greater than that of a gap between the bolt and the bushing in the radial direction.

An eighth aspect of the present disclosure may include: a speed reducing unit configured to reduce rotation input thereto; a first member having a housing portion housing the speed reducing unit; a mounting member to which the housing portion is fixedly attached, the mounting member having a through hole used to fixedly attach the housing portion to the mounting member; and a tubular buffer portion covering an inner wall of the through hole, the buffer portion having a first portion and a second portion with different degrees of deformability under a certain level of stress.

A ninth aspect of the present disclosure provides a construction machine including the speed reduce of each one of the first to eighth aspects described above.

A tenth aspect of the present disclosure provides a construction machine including: a speed reducer including: a speed reducing unit configured to reduce rotation input thereto; a first member having a housing portion housing the speed reducing unit, the first member having a through hole used to fixedly attach the housing portion to a mounting member; a tubular buffer portion covering an inner wall of the through hole, the buffer portion having a first portion and a second portion with different degrees of deformability under a certain level of stress; and a tubular bushing provided inside the buffer portion; the mounting member arranged next to the first member with a gap in a radial direction perpendicular to an axis of the through hole; and a bolt passing through the bushing to fixedly attach the housing portion to the mounting member. A width of the gap between the first member and the mounting member in the radial direction is greater than that of a gap between the bushing and the bolt in the radial direction.

An eleventh aspect of the present disclosure may include: a speed reducer including: a speed reducing unit configured to reduce rotation input thereto; and a first member having a housing portion housing the speed reducing unit; a mounting member to which the housing portion is fixedly attached, the mounting member having a through hole used to fixedly attach the housing portion to the mounting member; a tubular buffer portion covering an inner wall of the through hole, the buffer portion having a first portion and a second portion with different degrees of deformability under a certain level of stress; a tubular bushing provided inside the buffer portion; and a bolt passing through the bushing to fixedly attach the housing portion to the mounting member.

According to the present invention, required torque transmission can be accomplished while impacts can be mitigated before transmitted to the speed reducer.

### BRIEF DESCRIPTION OF DRAWINGS

FIG. 1 A sectional view of a construction machine relating to one embodiment.

FIG. 2 A sectional view of a speed reducer relating to one embodiment.

FIG. 3 An enlarged sectional view showing the portion demarcated by the dash-dot line III in FIG. 1.

FIG. 4 An enlarged sectional view showing a construction machine relating to a first modification example.

FIG. 5 A sectional view showing a construction machine relating to a second modification example.

FIG. 6 A sectional view showing a construction machine relating to a third modification example.

FIG. 7 A sectional view showing a construction machine relating to a fourth modification example.

FIG. 8 A sectional view showing a construction machine relating to a fifth modification example.

### DESCRIPTION OF EMBODIMENTS

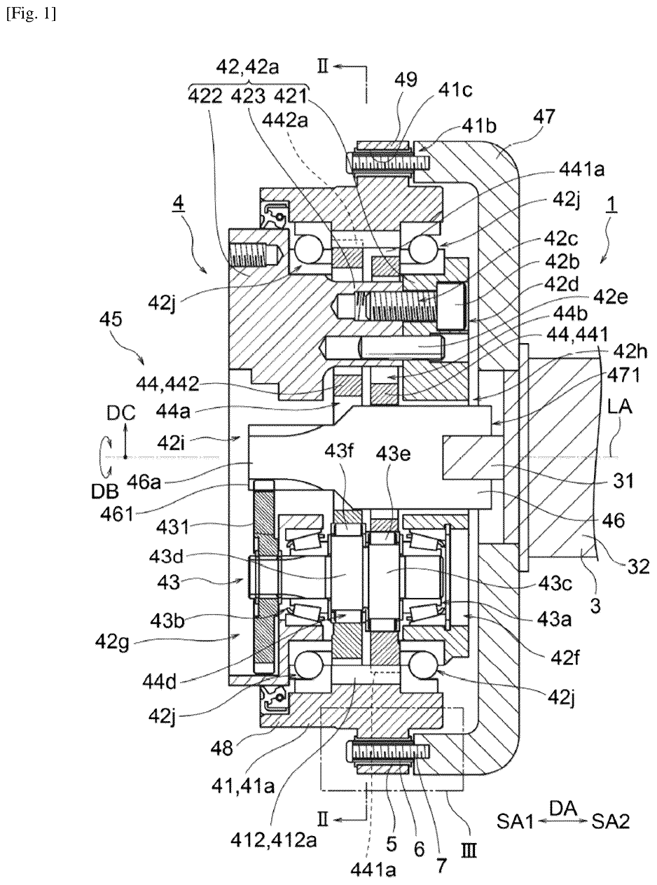

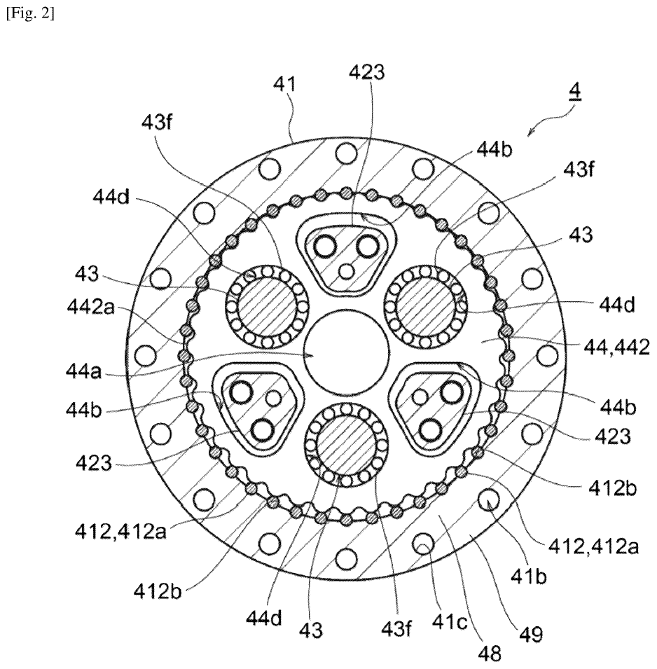

Embodiments of the present disclosure will now be described in detail with reference to the appended drawings. The following first describes a construction machine 1 with a built-in speed reducer 4 relating to an embodiment. FIG. 1 is a sectional view showing an example configuration of the construction machine 1 with the built-in speed reducer 4, more specifically, a part surrounding the speed reducer 4. More specifically, FIG. 1 is a sectional view of the construction machine 1 with the built-in speed reducer 4 along a plane passing through the rotation axis LA of the rotation output from the speed reducer 4. FIG. 2 is a sectional view showing the speed reducer 4 along the line II-II in FIG. 1.

The term “rotation axis direction DA” denotes the direction in which the rotation axis LA of the rotation output from the speed reducer 4 extends. In the rotation axis direction DA, a first side SA1 refers to the side where a base plate portion 422 of a second member 42 of the speed reducer 4 is positioned with respect to an end plate portion 421 of the second member 42. The base and end plate portions 422 and 421 of the second member 42 will be described below. In the rotation axis direction DA, a second side SA2 refers to the opposite side to the side where the base plate portion 422 of the second member 42 is positioned with respect to the end plate portion 421 of the second member 42. In FIG. 1, a mounting member 47 is positioned on the second side SA2 in the rotation axis direction DA with respect to the speed reducer 4. In addition, a rotation axis circumferential direction DB refers to the direction that circles around the rotation axis LA, and a rotation axis radial direction DC refers to the direction that is perpendicular to the rotation axis LA. In the rotation axis radial direction DC, a perpendicular line that can be drawn to the rotation axis LA extends.

The construction machine 1 includes the speed reducer 4 relating to the present embodiment. The construction machine 1 further includes an electric motor 3. The speed reducer 4 reduces the rotation input from the electric motor 3 and outputs the reduced rotation.

In the present embodiment, the electric motor 3 is a commonly used electric motor. The electric motor 3 includes a main body portion 32, and a rotating shaft 31 configured to rotate relative to the main body portion 32. In FIG. 1, the main body portion 32 of the electric motor 3 is fixedly attached to a mounting member 47, which will be described below. Although not shown, the electric motor 3 is fixedly attached to the surface of the mounting member 47 that faces the second side SA2, by being bolted to the mounting member 47. As shown in FIG. 1, the mounting member 47 has a through hole 471 extending through the mounting member 47 in the rotation axis direction DA. The rotating shaft 31 of the electric motor 3 is inserted through the through hole 471. The rotating shaft 31 protrudes toward the first side SA1 and extends in the rotation axial direction DA. Referring to FIG. 1, the rotation axis about which the rotating shaft 31 rotates coincides with the rotation axis LA of the rotation output from the speed reducer 4.

The speed reducer 4 will be hereinafter described. The speed reducer 4 is located on the first side SA1 with respect to the electric motor 3 in the rotation axis direction DA. The speed reducer 4 includes a speed reducing unit 45, a first member 41 and a buffer portion 5. The speed reducing unit 45 can reduce rotation input thereto. The first member 41 has a housing portion 48 housing the speed reducing unit 45. The first member 41 also has a through hole 41b used to fixedly attach the housing portion 48 to the mounting member 47, which will be described below. The buffer portion 5 is shaped like a tube and covers an inner wall 41c of the through hole 41b. As described below, the buffer portion 5 has a first portion 51 and a second portion 52 with different degrees of deformability under a certain level of stress. The speed reducer 4 relating to the present embodiment further includes a bushing 6, a bolt 7, the second member 42, and the mounting member 47, which will be described below. FIG. 1 does not show the shape of the first and second portions 51 and 52, and only presents the external shape of the buffer portion 5. In FIG. 2, the buffer portion 5, bushing 6, and bolt 7 are not shown.

The speed reducer 4 includes the second member 42 rotatable relative to the first member 41, in addition to the speed reducing unit 45, first member 41 and buffer portion 5. The speed reducing unit 45 can reduce the input from the electric motor 3 and cause the first and second members 41 and 42 to rotate relative to each other.

In the present embodiment, the first member 41 has internal teeth 412. The speed reducing unit 45 has crankshafts 43 rotatably supported by the second member 42, and external gears 44 having through holes 44d through which the crankshafts 43 pass and also having external teeth 441a and 442a. In the speed reducing unit 45, upon receiving a rotational input, the crankshafts 43 cause the external gears 44 to eccentrically oscillate. The external teeth 441a and 442a of the external gears 44 mesh with the internal teeth 412 of the first member 41. As a result of the eccentric oscillation, the external teeth 441a and 442a of the external gears 44 engage with the internal teeth 412 of the first member 41, thereby causing the first and second members 41 and 42 to rotate relative to each other.

In the present embodiment, the external gears 44 have the through holes 44d through which the crankshafts 43 pass.

The speed reducing unit 45 relating to the present embodiment includes a plurality of crankshafts 43. The crankshafts 43 extend through a plurality of through holes 44d in the external gears 44. The external gears 44 each have a plurality of through holes 44d, and the crankshafts 43 respectively extend through the through holes 44d.

In the present embodiment, the speed reducer 4 has a casing 41a shaped like a circular cylinder, as the first member 41. The speed reducing unit 4 has, as the second member 42, a carrier 42a positioned inside the casing 41a in the rotation axis radial direction DC (on the side closer to the rotation axis LA in the rotation axis radial direction DC). The speed reducer 4 has an input shaft 46 that provides a driving force to cause the carrier 42a to rotate. The mounting member 47 of the speed reducer 4 has the through hole 471, where the electric motor 3 is fixedly provided. The mounting member 47 is shaped like a circular tube.

The first member 41 (casing 41a) has a housing portion 48 housing the crankshafts 43 and external gears 44, which serve as the speed reducing unit 45. In the present embodiment, the housing portion 48 is a part of the casing 41a that is shaped like a circular tube. The first member 41 (casing 41a) has the through hole 41b used to fixedly attach the housing portion 48 to the mounting member 47. The through hole 41b extends in the rotation axis direction DA. The bolt 7, described below, may be inserted through the through hole 41b and screwed into the mounting member 47, so that the casing 41a is fixedly attached to the mounting member 47 and the housing portion 48 is fixedly attached to the mounting member 47. As the mounting member 47 is fixed onto the casing 41a and the electric motor 3 is fixed onto the mounting member 47, the electric motor 3 is fixed onto the casing 41a via the mounting member 47.

The inner peripheral surface of the casing 41a has the internal teeth 412. The internal teeth 412 are pin-shaped (cylindrical) teeth provided on the inner peripheral surface of the casing 41a. Specifically, the first member 41 has internal tooth pins 412a fitted into pin grooves 412b, as the internal teeth 412. The plurality of internal teeth 412 are arranged at equal intervals in the rotation axis circumferential direction DB.

The carrier 42a is rotatably supported on the casing 41a by means a pair of main bearings 42j. The main bearings 42j are spaced away from each other in the rotation axis direction DA. The main bearings 42j are, for example, angular contact ball bearings. The carrier 42a is positioned coaxially with the casing 41a and the rotation axis LA.

The carrier 42a includes the end plate portion 421 situated on the second side SA2 in the rotation axis direction DA, the base plate portion 422 situated on the first side SA1 in the rotation axis direction DA, and three columnar portions 423 that are integrally molded with the base plate portion 422 and protrude from the base plate portion 422 toward the end plate portion 421. The end plate portion 421 and base plate portion 422 are shaped like a circular plate. The columnar portions 423 shown in FIG. 2 are shaped like a column, and their section perpendicular to the rotation axis direction DA is substantially shaped like a triangle with rounded vertices. The columnar portions 423 are arranged at equal intervals in the rotation axis circumferential direction DB. The columnar portions 423 are fixed onto the end plate portion 421 by means of bolts 42b, which fasten together the columnar portions 423 and end plate portion 421 with the end surface of the columnar portions 423 being overlaid onto the end plate portion 421. In this way, a space having a predetermined width in the rotation axis direction DA is formed between the base plate portion 422 and the end plate portion 421.

The columnar portions 423 each have a bolt fastening hole 42c into which the bolt 42b is tightened. The end plate portion 421 has a plurality of bolt holes 42d into which the bolts 42b are inserted. The bolts 42b are inserted into the bolt insertion holes 42d from the side opposite to the columnar portions 423 across the end plate portion 421, and tightened into the bolt fastening holes 42c in the columnar portions 423. Pins 42e for aligning the end plate portion 421 with the base plate portion 422 are provided inside the bolts 42b, along the rotation axis radial direction DC. The pins 42e span the columnar portions 423 and the end plate portion 421. The columnar portions 423 and the base plate portion 422 may not be integrally molded. In this case, the columnar portions 423 are fastened to the base plate portion 422. Furthermore, the columnar portions 423 may be shaped in any other manner than like a column having a section perpendicular to the rotation axis direction DA shaped like a triangle with rounded vertices. The columnar portions 423 can be shaped or configured in any manner as long as they form a space having a predetermined width in the rotation axis direction DA between the base plate portion 422 and the end plate portion 421. The columnar portions 423 may be shaped like a circular column.

The end and base plate portions 421 and 422 respectively have a plurality of (for example, three in this embodiment) holes 42f and 42g, into which the crankshafts 43 of the speed reducing unit 45 are inserted. The holes 42f, 42g are arranged at equal intervals in the rotation axis circumferential direction DB. The end and base plate portions 421 and 422 each have a through hole 42h, 42i at the center in the rotation axis radial direction DC extending in the rotation axis direction DA. The through holes 42h and 42i receive therein the input shaft 46. The input shaft 46 is positioned coaxially with the casing 41a and the rotation axis LA.

The base end of the input shaft 46 that faces the electric motor 3 (faces the second side SA2 in the rotation axis direction DA) is coupled with the rotating shaft 31 of the electric motor 3. As a result, the input shaft 46 can rotate together with the rotating shaft 31. The end 46a of the input shaft 46 that faces away from the electric motor 3 (faces the first side SA1 in the rotation axis direction DA) is located inside the through hole 42i of the base plate portion 422. The input shaft 46a has a drive gear 461 at the end 46a. The drive gear 461 has external teeth and is combined with the input shaft 46 into a single part.

The speed reducing unit 45 causes the carrier 42a to rotate at a rotational speed that is reduced by a certain ratio from the rotational speed of the input shaft 46. The speed reducing unit 45 includes a plurality of (for example, three in this embodiment) transmission gears 431 that mesh with the drive gear 461, and a plurality of (for example, three in this embodiment) crankshafts 43 each having an end fixed to a corresponding one of the transmission gears 431. The transmission gears 431 are each fixedly attached to the end of the corresponding crankshaft 43 that faces the first side SA1 in the rotation axis direction DA. In the present embodiment, the speed reducing 45 has, as the external gears 44, first and second external gears 441 and 442 that can oscillatorily rotate as the crankshafts 43 rotate.

Since the transmission gears 431 are fixed to the ends of the crankshafts 43, the rotation of the rotating shaft 31 is transmitted to the crankshafts 43 via the transmission gears 431. The crankshafts 43 may be arranged so as to extend parallel to the input shaft 46. This means that each of the crankshafts 43 rotates about an axis of rotation parallel to the rotation axis LA of the rotation output from the speed reducer 4. Each crankshaft 43 is rotatably supported on the end plate portion 421 via a first crank bearing 43a. Each crankshaft 43 is rotatably supported on the base plate portion 422 via a second crank bearing 43b. The first and second crank bearings 43a and 43b are, for example, tapered roller bearings.

At the center of the crankshaft 43 in the rotation axis direction DA, a first eccentric portion 43c and a second eccentric portion 43d are provided eccentrically from the axis of the crankshaft 43. The first and second eccentric portions 43c, 43d are disposed adjacent to each other in the rotation axis direction DA between the first crank bearing 43a and the second crank bearing 43b. The first eccentric portion 43c is adjacent to the first crank bearing 43a. The second eccentric portion 43d is adjacent to the second crank bearing 43b. The first and second eccentric portions 43c and 43d are out of phase with each other.

The crankshaft 43 thus configured is inserted into the holes 42f and 42g in the end and base plate portions 421 and 422. That is, the plurality of crankshafts 43 are arranged at equal intervals in the rotation axis circumferential direction DB like the holes 42f and 42g.

A first roller bearing 43e is attached to the first eccentric portion 43c of the crankshaft 43. A second roller bearing 43f is attached to the second eccentric portion 43d. The first roller bearing 43e is, for example, a cylindrical roller bearing. The first and second external gears 441 and 442 can oscillatorily rotate in conjunction with the rotation of the crankshafts 43 via the roller bearings 43e and 43f.

The first and second external gears 441 and 442 are disposed in a space between the base plate portion 422 and the end plate portion 421 of the carrier 42a. The first and second external gears 441 and 442 have external teeth 441a and 442a, respectively, that mesh with the internal teeth 412 of the casing 41a. The first and second external gears 441 and 442 each have a first through hole 44a centered around the rotation axis LA, second through holes 44b into which the columnar portions 423 are inserted, and through holes 44d into which the crankshafts 43 are inserted. The through holes 44d receive the eccentric portions 43c and 43d of the crankshafts 43. The input shaft 46 passes through the first through hole 44a.

The first eccentric portions 43c of the crankshafts 43 and the first roller bearings 43e are inserted into the through holes 44d of the first external gear 441. The second eccentric portions 43d of the crankshafts 43 and the second roller bearings 43f are inserted into the through holes 44d of the second external gear 442. The first and second eccentric portions 43c and 43d oscillatorily rotate as the crankshafts 43 rotate, as a result of which the first and second external gears 441 and 442 oscillatorily rotate while meshing with the internal teeth 412 of the casing 41a.

The following now describes how the speed reducer 4 works. As the electric motor 3 is driven, the rotating shaft 31 and the input shaft 46 are together driven. As the input shaft 46 rotates, the transmission gears 431 may rotate via the drive gear 461. Accordingly, the crankshafts 43 may rotate together with the transmission gears 431.

Upon rotation of the crankshafts 43, the first eccentric portions 43c oscillate and the first external gear 441 resultantly rotates while meshing with the internal teeth 412. Likewise, the second eccentric portions 43d oscillate and the second external gear 442 resultantly rotates while meshing with the internal teeth 412. That is, the crankshafts 43 rotate on their axes of rotation that are parallel to the rotation axis LA of the rotation output from the speed reducer 4 and also revolve around the rotation axis LA. In this manner, the rotation of the crankshafts 43 causes the first and second external gears 441 and 442 to rotate.

As the first and second external gears 441 and 442 are driven, the second member 42 (carrier 42a), which has the columnar portions 423 passing through the first and second external gears 441 and 442, is driven by the first and second external gears 441 and 442. As a result, the carrier 42a rotates relative to the casing 41a, which is fixedly attached to the electric motor 3 via the mounting member 47, at a rotation speed slower than that of the input shaft 46. In this manner, the speed reducer 4 can reduce the rotation of the electric motor 3.

According to the above description of the speed reducer 4, the speed reducing unit 45 has the crankshafts 43 and external gears 44, but the speed reducer 4 can be configured in any other manners. Alternatively, the speed reducing unit 45 of the speed reducer 4 may have a planetary gear rotatably supported by the second member 42. Upon receiving rotational input, the planetary gear may mesh with the internal teeth 412 of the first member 41, thereby causing the first and second members 41 and 42 to rotate relative to each other. In other words, the speed reducer 4 may be configured as a planetary-geared speed reducer.

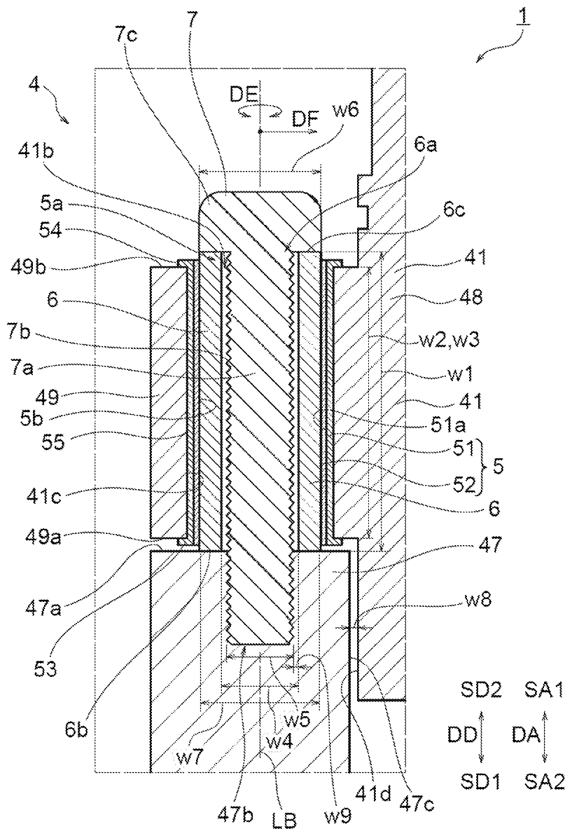

The following describes the through hole 41b in detail, and also describes the buffer portion 5 and bushing 6. In the present embodiment, the first member 41 has a plurality of through holes 41b. FIG. 3 is an enlarged sectional view showing the portion demarcated by the dash-dot-dot line III in FIG. 1. The dash-dot line identified by the label LB in FIG. 1 is an imaginary line indicating the axis LB of the through hole 41b. The axis LB is an imaginary line passing through the center of gravity of the section of the through hole 41b. For example, if the through hole 41b is shaped like a circular column, the axis LB is a straight line passing through the center of the circular section of the through hole 41b. The direction in which the through hole 41b extends (the direction in which the axis LB of the through hole 41b extends) is also referred to as the axial direction DD. In the present embodiment, the axial direction DD in which the through hole 41b extends is parallel to the rotation axis direction DA in which the rotation axis LA of the rotation output from the speed reducer 4 extends. In the axial direction DD, a first side SD1 refers to the side where the mounting member 47 is positioned with respect to the through hole 41b. In the axial direction DD, a second side SD2 refers to the opposite side to the side where the mounting member 47 is positioned with respect to the through hole 41b. The term “circumferential direction DE” refers to the direction that circles around the axis LB of the through hole 41b. The term “radial direction DF” refers to the direction perpendicular to the axis LB of the through hole 41b. In the radial direction DF, a perpendicular line that can be drawn to the axis LB extends.

In the present embodiment, the plurality of through holes 41b are arranged next to each other in the rotation axis circumferential direction DB that circles around the rotation axis LA. The plurality of through holes 41b surround the housing portion 48 from outside, along the rotation axis radial direction DC that is perpendicular to the rotation axis LA. The number of through holes 41b depends on the magnitude of torque required to be transmitted from the electric motor 3 to the speed reducer 4. Here, the buffer portion 5, described below, is provided in each of the through holes 41b.

In the present embodiment, the first member 41 further has a flange portion 49 protruding from the housing portion 48 in a direction that intersects the axial direction DD in which the through hole 41b extends. The flange portion 49 faces the mounting member 47. In the present embodiment, the flange portion 49 protrudes outward in the rotation axis radial direction DC from the housing portion 48. The flange 49 extends in the rotation axis circumferential direction DB. The flange portion 49 thus surrounds the housing portion 48 from outside, along the rotation axis radial direction DC. The flange portion 49 has the through holes 41b. In the present embodiment, the mounting member 47 has a mounting surface 47a that has threaded holes 47b. The flange portion 49 has a surface facing the mounting surface 47a. The surface of the flange portion 49 that faces the mounting surface 47a (the surface facing the first side SD1 in the axial direction DD) is referred to as the first surface 49a. The surface of the flange portion 49 that faces away from the first surface 49a in the axial direction DD (the surface that faces the second side SD2 in the axial direction DD) is referred to as the second surface 49b. In the present embodiment, the first surface 49a, second surface 49b and mounting surface 47a are perpendicular to the axial direction DD. The through holes 41b open to the first and second surfaces 49a and 49b of the flange portion 49.

The speed reducer 4 has the buffer portion 5 that is shaped like a tube and that cover the inner wall 41c of the through hole 41b. The buffer portion 5 is designed to, when the mounting member 47 is impacted, mitigate the impact transmitted from the mounting member 47 to the first member 41. In the present embodiment, the buffer portion 5 is substantially shaped like a circular tube. Having a tubular shape, the buffer portion 5 has a buffer portion through hole 5a extending in the axial direction DD. The bolt 7, described below, passes through the buffer portion through hole 5a. In the present embodiment, the buffer portion 5 is tightly attached to the inner wall 41c of the through hole 41b and present continuously in the circumferential direction DE. The buffer portion 5 is fixedly attached to the inner wall 41c of the through hole 41b. The buffer portion 5 is fixedly attached to the inner wall 41c of the through hole 41b by being bonded to the inner wall 41c of the through hole 41b using, for example, an adhesive.

The buffer portion 5 has a first portion 51 and a second portion 52 with different degrees of deformability under a certain level of stress. The first and second portions 51 and 52 are shaped like a tube. In the present embodiment, the first portion 51 is substantially shaped like a circular tube. The second portion 52 is shaped like a circular tube. The second portion 52 is located inside the first portion 51 in the radial direction DF (on the side closer to the axis LB in the radial direction DF). The first portion 51 is fixedly attached to the inner wall 41c of the through hole 41b and present continuously in the circumferential direction DS. The second portion 52 is fixedly attached to the inner wall 51a of the first portion 51 continuously in the circumferential direction DE. The second portion 52 is fixedly attached to the inner wall 51a of the first portion 51 by being bonded to the inner wall 51a of the first portion 51 using, for example, an adhesive.

In the present embodiment, the second portion 52 is more easily deformed than is the first portion 51 when subjected to a certain level of stress. Here, the degree of deformability under a certain level of stress can be indicated by, for example, the amount of elongation experienced by the first and second portions 51 and 52 when they are subjected to a certain level of tensile stress. Specifically, the amount of elongation under a certain level of tensile stress is measured for the first and second portions 51 and 52. If the amount of elongation is greater for the second portion 52 than for the first portion 51, the second portion 52 can be considered to have a higher degree of deformability under a certain level of stress than the first portion 51. The first and second portions 51 and 52 can be compared in terms of the amount of elongation under a certain level of tensile stress, for example, in the following manner. In compliance with JIS K 6251:2017, test strips of the same shape are produced for the first and second portions 51 and 52, and a tensile test machine is prepared. The tensile test machine is used to pull the test strips in order to apply a certain level of tensile stress to the test strips. The amount of elongation experienced by the test strips is then measured while the test strips are being pulled. In terms of the measured amount of elongation, the test strips for the first and second portions 51 and 52 are compared.

Alternatively, the degree of deformability under a certain level of stress can be indicated by, for example, the amount of shrinkage experienced by the first and second portions 51 and 52 when they are subjected to a certain level of compression stress. Specifically, the amount of shrinkage under a certain level of compression stress is measured for the first and second portions 51 and 52. If the amount of shrinkage is greater for the second portion 52 than for the first portion 51, the second portion 52 can be considered to have a higher degree of deformability under a certain level of stress than the first portion 51. The first and second portions 51 and 52 can be compared in terms of the amount of shrinkage under a certain level of compression stress, for example, in the following manner. In compliance with JIS K 6254:2016, test strips of the same shape are produced for the first and second portions 51 and 52, and a compression test machine is prepared. The compression test machine is used to pull the test strips in order to apply a certain level of compression stress to the test strips. The amount of shrinkage experienced by the test strips is then measured while the test strips are being pulled. In terms of the measured amount of shrinkage, the test strips for the first and second portions 51 and 52 are compared.

In the present embodiment, the buffer portion 5 has a first flange portion 53 that overlaps the first surface 49a of the flange portion 49, and a second flange portion 54 that overlaps the second surface 49b of the flange portion 49. The buffer portion 5 has a buffer portion main body 55 shaped like a circular tube, the first flange portion 53, and the second flange portion 54. The first flange portion 53 is connected to the end of the buffer portion main body 55 that faces the first side SD1 in the axial direction DD. The second flange portion 54 is connected to the end of the buffer portion main body 55 that faces the second side SD2 in the axial direction DD. The first and second flange portions 53 and 54 extend outward in the radial direction DF from the buffer portion main body 55. The first flange portion 53 is in contact with the first surface 49a of the flange portion 49. The second flange portion 54 is in contact with the second surface 49b of the flange portion 49.

In the present embodiment, the first portion 51, which is located outside the second portion 52 in the radial direction DF (on the side farther from the axis LB in the radial direction DF) and has a lower degree of deformability under a certain level of stress than the second portion 52, has the first and second flange portions 53 and 54.

In the present embodiment, the first and second portions 51 and 52 show higher degree of deformability when subjected to a certain level of stress than the mounting member 47, first member 41, bolt 7 and bushing 6, which will be described below. The relatively high degree of deformability of the first and second portions 51 and 52 under a certain level of stress may be achieved through appropriate selection of the material of the first and second portions 51 and 52, or through a high ratio of voids in the first and second portions 51 and 52. The first and second portions 51 and 52 can be made of any materials as long as they can mitigate the impact transmitted from the mounting member 47 to the first member 41. The first and second portions 51 and 52 may be made of a resin or metal. For example, the first and second portions 51 and 52 are made of rubber.

Having the first and second flange portions 53 and 54, the buffer potion 5 can be prevented from coming out of the through hole 41b.

The speed reducer 4 further includes the bushing 6. The bushing 6 is provided inside the buffer portion 5 and shaped like a tube. In the present embodiment, the bushing 6 is shaped like a circular tube. Having a tubular shape, the bushing 6 has a bushing through hole 6a extending in the axial direction DD. The bolt 7, described below, passes through the bushing through holes 6a. In the present embodiment, the bushing 6 is tightly attached to the inner wall 5b of the buffer portion through hole 5a and continuously present in the circumferential direction DE. The bushing 6 is fixedly attached to the inner wall 5b of the buffer portion through hole 5a. The bushing 6 is fixedly attached to the inner wall 5b of the buffer portion through hole 5a by being bonded to the inner wall 5b of the buffer portion through hole 5a using, for example, an adhesive. The end of the bushing 6 that faces the first side SD1 in the axial direction DD is referred to as the first end 6b. The end of the bushing 6 that faces the second side SD2 in the axial direction DD is referred to as the second end 6c.

The bushing 6 can be made of a material that allows the bushing 6 to be fixedly attached to the mounting member 47 by means of the bolt 7. In the present embodiment, the bushing 6 is made of a metal. For example, the bushing 6 is made of iron.

In the present embodiment, the dimension w1 of the bushing 6 in the axial direction DD in which the through hole 41b extends is greater than the dimension w2 of the through hole 41b in the axial direction DD. Therefore, the bushing 6 may protrude beyond the through hole 41b on both sides.

In the present embodiment, the dimension w1 of the bushing 6 in the axial direction DD is greater than the dimension w3 of the flange portion 49 in the axial direction DD. Therefore, the first end 6b of the bushing 6 can be positioned on the first side SD1 in the axial direction DD with respect to the first surface 49a of the flange portion 49, and the second end 6c of the bushing 6 can be positioned on the second side SD2 in the axial direction DD with respect to the second surface 49b of the flange portion 49.

The speed reducer 4 relating to the present embodiment further includes the bolt 7 passing through the bushing 6 to fixedly attach the housing portion 48 to the mounting member 47. In the present embodiment, the bolt 7 has a shaft portion 7a with external threads 7b, and a head 7c provided on one of the ends of the shaft portion 7a. The dimension w4 of the bushing through hole 6a in the radial direction DF perpendicular to the axis LB of the through hole 41b is equal to or greater than the dimension w5 of the shaft portion 7a in the radial direction DF. The dimension w4 of the bushing through hole 6a in the radial direction DF is less than the dimension w6 of the head 7c in the radial direction DF. Therefore, the bushing 6 can be sandwiched between the head 7c and the mounting member 47, by inserting the shaft portion 7a through the bushing through hole 6a and screwing the end of the shaft portion 7a that is opposite the end where the head 7c is provided into the threaded hole 47b of the mounting member 47. The bushing 6 is fixedly attached to the mounting member 47 by being sandwiched between the head 7c and the mounting member 47. In the present embodiment, the bushing 6 is fixedly attached to the inner wall 5b of the buffer portion through hole 5a, and the buffer portion 5 is fixedly attached to the inner wall 41c of the through hole 41b. Therefore, the first member 41 having the housing portion 48 is fixedly attached to the mounting member 47 via the bushing 6 and buffer portion 5, by fixing the bushing 6 to the mounting member 47 by means of the bolt 7.

The dimension w7 of the bushing 6 in the radial direction DF perpendicular to the axis LB of the through hole 41b is equal to or greater than the dimension w6 of the head 7c of the bolt 7 in the radial direction DF.

In the present embodiment, the speed reducer 4 further includes the mounting member 47 arranged next to the first member 41 with a gap in the radial direction DF perpendicular to the axis LB of the through hole 41b. In the present embodiment, the mounting member 47 thus constitutes part of the speed reducer 4. As described above, the mounting member 47 relating to the present embodiment is the member to which the electric motor 3 is fixed.

The first member 41 and mounting member 47 may have surfaces facing each other in the radial direction DF. In FIG. 3, the surface 41d of the first member 41 and the surface 47c of the mounting member 47 face each other in the radial direction DF. In the present embodiment, the width w8 of the gap between the first member 41 and the mounting member 47 in the radial direction DF is greater than the width w9 of the gap between the bushing 6 and the bolt 7 in the radial direction DF.

From among the distances between the first member 41 and the mounting member 47 measured in all of the directions parallel to the plane perpendicular to the axis LB of the through hole 41b, the width w8 of the gap between the first member 41 and the mounting member 47 in the radial direction DF is the shortest distance between the first member 41 and the mounting member 47. The width w9 of the gap between the bushing 6 and the bolt 7 in the radial direction DF is the gap between the bushing 6 and the bolt 7 in the radial direction DF when the bolt 7 is placed in the through hole 41b such that the axis of the bolt 7 coincides with the axis LB of the through hole 41b.

As described above, the speed reducer 4 of the present embodiment includes: the speed reducing unit 45 configured to reduce the rotation input thereto; the first member 41 having the housing portion 48 housing the speed reducing unit 45, the first member 41 having the through hole 41b used to fixedly attach the housing portion 48 to the mounting member 47; and the buffer portion 5 shaped like a tube, the buffer portion 5 covering the inner wall 41c of the through hole 41b, the buffer portion 5 having the first and second portions 51 and 52 with different degrees of deformability under a certain level of stress. The number of through holes 41b depends on the amount of torque required to be transmitted from the electric motor 3 to the speed reducer 4. Here, the buffer portion 5 is provided in each of the through holes 41b. The speed reducer 4 described above can produce the following advantageous effects. The mounting member 47 may be subjected to impacts. For example, the speed reducer 4 may be included in the construction machine 1 such as an excavator. In this case, the construction machine 1 may be subjected to impacts from outside, and the impacts may be transmitted to the mounting member 47. In this manner, the mounting member 47 may experience impacts. Here, the impacts affecting the mounting member 47 are probably transmitted to the bolt 7, which is received in the through hole 41b and screwed into the threaded hole 47b of the mounting member 47. Experiencing the impacts, the bolt 7 may move in the radial direction DF. This may impact the first member 41. If the speed reducer 4 further has the bushing 6, the impacts experienced by the bolt 7 may cause the bolt 7 and bushing 6 to move in the radial direction DF, and the impacts experienced by the bolt 7 may be transmitted to the first member 41 via the bushing 6. The speed reducer 4 relating to the present embodiment has the buffer portion 5 shaped like a tube and covering the inner wall 41c of the through hole 41b. The buffer portion 5 is interposed between the bolt 7 and the first member 41 in the radial direction DF. The bolt 7 may move in the radial direction DF to impact the first member 41. If such occurs, the buffer portion 5 can mitigate the impact transmitted from the bolt 7 to the first member 41. As a result, the buffer portion 5 can mitigate the impact transmitted from the bolt 7 to the speed reducing unit 45 via the first member 41. As described above, the buffer potion 5 can mitigate the impact transmitted to the speed reducer 4, more specifically, the components of the speed reducer 4 such as the first member 41 and speed reducing unit 45.

In the present embodiment, the buffer portion 5 has the first and second portion 51 and 52 with different degrees of deformability under a certain level of stress. In the present embodiment, the second portion 52 shows a higher degree of deformability than the first portion 51 when subjected to a certain level of stress. The first and second portions 51 and 52 are shaped like a tube. Since the buffer portion 5 has the first and second portions 51 and 52, the following advantageous effects are provided. The bolt 7 may move in the radial direction DF to impact the first member 41. If such occurs, the second portion 52 with a high degree of deformability can effectively mitigate the impact. The impact transmitted from the bolt 7 may be so significant that the second portion 52 may deform to the point where the second portion 52 can not deform any more. In this case, the first portion 51, which has a lower degree of deformability than the second portion 52, can mitigate the impact.

Since the buffer portion 5 has the first and second portions 51 and 52, the following advantageous effects are also provided. Configured in this way, the buffer portion 5 is less easily deformed than when the buffer portion 5 is only constituted by the second portion 52, which has a higher degree of deformability than the first portion 51. When rotation is input into the speed reducer 4, the input rotational force may be released through the buffer portion 5. In the present embodiment, however, this can be prevented. In the present embodiment, the rotation is input into the speed reducer 4 from the electric motor 3 fixedly attached to the mounting member 47. The rotational force input from the electric motor 3 can be prevented from being released through the buffer portion 5. More specifically, the first portion 51, which has a lower degree of deformability than the second portion 52, can be designed to be unlikely to deform when subjected to a force usually applied by the rotation input into the speed reducer 4. In this case, upon input of rotation into the speed reducer 4, the second portion 52 may deform but the first portion 51 does not. Since the rotation input into the speed reducer 4 does not cause the first portion 51 to deform, the buffer portion 5 lessens the rotational force less significantly. Thus, torque can be appropriately transmitted from the electric motor 3 to the speed reducer 4. As described above, rotation can be efficiently input into the speed reducer 4 even with the buffer portion 5.

As described above, the buffer portion 5 relating to the present embodiment can be configured as follows. The second portion 52 can be designed such that, when the bolt 7 moves in the radial direction DF to impact the first member 41, the second portion 52 can deform to a greater extent than the first portion 51 to mitigate the impact more significantly. The first portion 51 can be designed to additionally mitigate the impact if the second portion 52 deforms to the maximum extent since the bolt 7 moves in the radial direction DF to particularly significantly impact the first member 41. The first portion 51 can be designed such that it is unlikely to deform when subjected to a force usually applied by the rotation input into the speed reducer 4. Since the buffer portion 5 is provided in the speed reducer 4, the impact transmitted from the bolt 7 to the first member 41 in the radial direction DF can be mitigated while the rotation can be highly efficiently input into the speed reducer 4 and the speed reducer 4 can highly efficiently output the reduced rotation.

The speed reducer 4 relating to the present embodiment further includes the bushing 6. The bushing 6 is provided inside the buffer portion 5 and shaped like a tube. Therefore, by fixedly attaching the bushing 6 to the buffer portion 5, fixedly attaching the buffer portion 5 to the first member 41, fixedly attaching the bushing 6 to the mounting member 47 by means of the bolt 7, the first member 41 having the housing portion 48 can be reliably fixed to the mounting member 47 via the bushing 6 and the buffer section 5.

In the present embodiment, the dimension w1 of the bushing 6 in the axial direction DD in which the through hole 41b extends is greater than the dimension w2 of the through hole 41b in the axial direction DD. Therefore, the bushing 6 may protrude beyond the through hole 41b on both sides. In the present embodiment, the dimension w1 of the bushing 6 in the axial direction DD is greater than the dimension w3 of the flange portion 49 in the axial direction DD. As a result, the first end 6b of the bushing 6 can be positioned on the first side SD1 in the axial direction DD with respect to the first surface 49a of the flange portion 49, and the second end 6c of the bushing 6 can be positioned on the second side SD2 in the axial direction DD with respect to the second surface 49b of the flange portion 49.

As the bushing 6 is arranged in the above-described manner, the following advantageous effects can be further produced. The first end 6b of the bushing 6 is in contact with the mounting surface 47a of the mounting member 47 as the bushing 6 extends beyond the through hole 41b on the first side SD1, and the first end 6b of the bushing 6 is positioned on the first side SD1 in the axial direction DD with respect to the first surface 49a of the flange portion 49. This results in separating the mounting surface 47a of the mounting member 47 from the surface of the first member 41 (the first surface 49a of the flange portion 49) that faces the mounting surface 47a in the axial direction DD. This can prevent direct contact between the mounting member 47 and the first member 41 in the axial direction DD, thereby preventing impacts from being directly transmitted from the mounting member 47 to the first member 41 in the axial direction DD. Furthermore, the following advantageous effects can be produced since the bushing 6 extends beyond the through hole 41b on the second side SD2, so that the second end 6c of the bushing 6 can be positioned on the second side SD2 in the axial direction DD with respect to the second surface 49b of the flange portion 49. When the bushing 6 is sandwiched between the head 7c of the bolt 7 and the mounting member 47 to fixedly attach the bushing 6 to the mounting member 47, the head 7c of the bolt 7 does not come in contact with the first member 41. This prevents direct impact transmission from the head 7c of the bolt 7 to the first member 41.

The speed reducer 4 relating to the present embodiment further includes the bolt 7 passing through the bushing 6 to fixedly attach the housing portion 48 to the mounting member 47. The dimension w7 of the bushing 6 in the radial direction DF perpendicular to the axis LB of the through hole 41b is equal to or greater than the dimension w6 of the head 7c of the bolt 7 in the radial direction DF. This also prevents the head 7c of the bolt 7 from touching the first member 41 when the bushing 6 is sandwiched between the head 7c of the bolt 7 and the mounting member 47 to fixedly attach the bushing 6 to the mounting member 47. This prevents direct impact transmission from the head 7c of bolt 7 to the first member 41. In addition, the head 7c can contact the bushing 6 over a sufficient area when the bushing 6 is sandwiched between the head 7c of bolt 7 and the mounting member 47 to fixedly attach the bushing 6 to the mounting member 47. In this manner, the bushing 6 can be stably fixed onto the mounting member 47, the rotation can be highly efficiently input into the speed reducer 4 from the electric motor 3 fixedly attached to the mounting member 47, and the speed reducer 4 can highly efficiently output the reduced rotation.

The speed reducer 4 relating to the present embodiment further includes the second member 42 rotatable relative to the first member 41. The first member 41 has the internal teeth 412. The speed reducing unit 45 has the crankshafts 43 rotatably supported by the second member 42, and the external gears 44 having the through holes 44d through which the crankshafts 43 pass and also having the external teeth 441a and 442a meshing with the internal teeth 412 of the first member 41. According to the present embodiment, the speed reducer 4 configured in this manner can be reliably protected against impacts.

In the present embodiment, the speed reducer 4 further includes the mounting member 47 arranged next to the first member 41 with a gap in the radial direction DF perpendicular to the axis LB of the through hole 41b, and also includes the bolt 7 passing through the bushing 6 and fixedly attaching the housing portion 48 to the mounting member 47. The width w8 of the gap between the first member 41 and the mounting member 47 in the radial direction DF is greater than the width w9 of the gap between the bushing 6 and the bolt 7 in the radial direction DF. This characteristic configuration can produce the following advantageous effects. When the mounting member 47 experiences an impact and accordingly moves in the radial direction DF to transmit the impact to the first member 41, a surface of the mounting member 47 other than the mounting surface 47a may come into direct contact with a surface of the first member 41. For example, the surface 41d of the first member 41 and the surface 47c of the mounting member 47, which face each other in the radial direction DF in FIG. 3, could be in direct contact. Here, the width w8 is greater than the width w9. The mounting member 47 may experience an impact and accordingly move in the radial direction DF, but the bolt 7 can come into contact with the buffer portion 5 in the radial direction DF before the surface of the mounting member 47 comes into direct contact with the surface of the first member 41 in the radial direction DF. The buffer portion 5 can thus mitigate the impact before the surface of the mounting member 47 comes into direct contact with the surface of the first member 41 in the radial direction DF. If the surface of the mounting member 47 directly comes into contact with the surface of the first member 41 in the radial direction DF, a strong impact can be transmitted from the mounting member 47 to the first member 41. The present embodiment can prevent this issue.

The speed reducer 4 relating to the present embodiment described above may be used in the construction machine 1. In this case, the speed reducer 4 can constitute the construction machine 1. The construction machine 1 may be an excavator, for example. If the construction machine 1 is an excavator, the speed reducer 4 can output rotation to drive, for example, the boom, arm, bucket of the excavator. If the speed reducer 4 relating to the present embodiment is included in the construction machine 1, any impacts can be mitigated before transmitted to the first member 41 of the speed reducer 4 while the construction machine 1 is driven by the rotation reduced by the speed reducer 4.

While the foregoing has described the embodiment through specific examples, these specific examples are not intended to limit the embodiment. The foregoing embodiment can be implemented in various other specific forms and is susceptible to omission, replacement, modification and addition of various elements thereof within the purport of the invention.

With reference to the appended drawings, the following describes modification examples. In the following description and the drawings used therein, parts that can be configured in a similar manner to those in the foregoing specific examples are denoted by the same reference signs as those in the foregoing specific examples and are not described again.

### First Modification Example

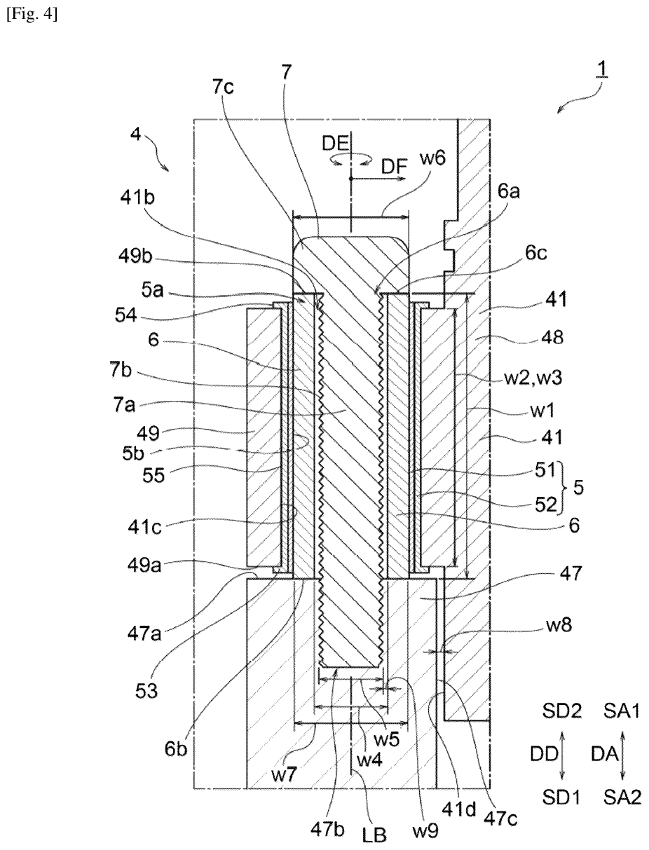

In the buffer portion 5 relating to the above-described embodiment, the second portion 52, which has a higher degree of deformability than the first portion 51 under a certain level of stress, is located inside the first portion 51 in the radial direction DF. However, the buffer portion 5 may be configured in any other manners. FIG. 4 is an enlarged sectional view showing a part of a construction machine 1 relating to a first modification example, specifically, a part near a buffer portion 5. FIG. 4 is a sectional view showing the construction machine 1 along a plane passing the axis LB of the through hole 41b.

According to the first modification example, the second portion 52, which has a higher degree of deformability than the first portion 51 under a certain level of stress, is located inside the first portion 51 in the radial direction DF. In this case, the buffer portion 5 having the first and second portions 51 and 52 can mitigate the impact transmitted from the bolt 7 to the first member 41, while allowing the rotation to be input into the speed reducer 4 highly efficiently and allowing the speed reducer 4 to output the reduced rotation highly efficiently.

According to the first modification example, the first portion 51, which is located inside the second portion 52 along the radial direction DF, has the first and second flange portions 53 and 54. In this case, the first and second flange portions 53 and 54 can still prevent the buffer portion 5 from coming out of the through hole 41b.

### Second Modification Example

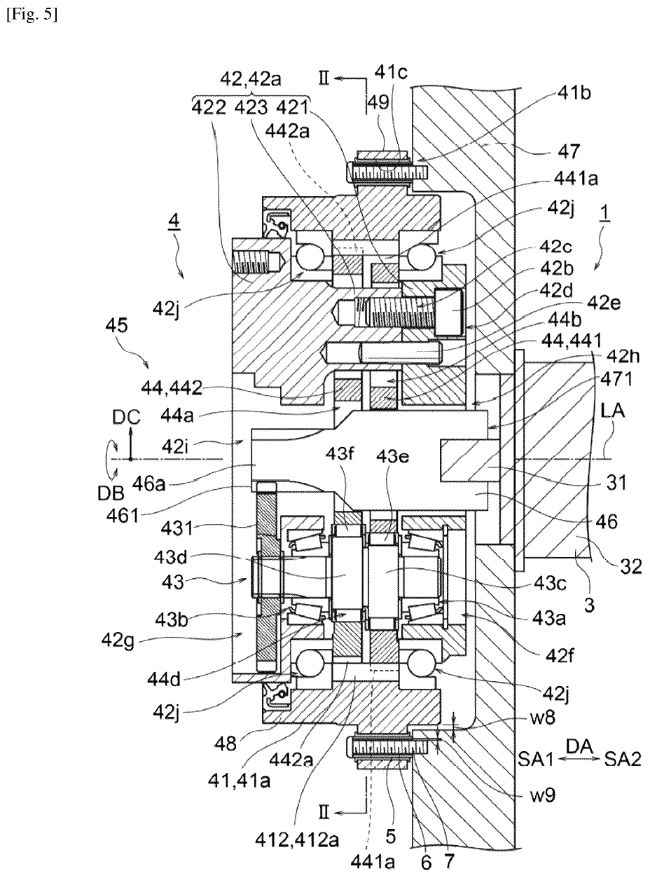

According to the embodiment and modification example described above, the mounting portion 47 constitutes part of the speed reducer 4. However, the mounting member 47 may be configured in any other manners. FIG. 5 is a sectional view showing an example configuration of the construction machine 1 with a built-in speed reducer 4 relating to a second modification example, more specifically, a part surrounding the speed reducer 4. More specifically, FIG. 5 is a sectional view of the construction machine 1 along a plane passing through the rotation axis LA of the rotation output from the speed reducer 4.

According to the second modification example, the mounting member 47 is a relatively large member of the construction machine 1, when compared to the first member 41 and speed reducing unit 45 of the speed reducer 4. For example, the mounting member 47 relating to the second modification example is a member to be driven by the rotation output from the speed reducing unit 45. If the construction machine 1 is an excavator, for example, the mounting member 47 relating to the second modification example is a member constituting, for example, the boom, arm, bucket of the excavator. According to the second modification example, the electric motor 3 is directly fixed onto a mounting member 47.

In other words, the construction machine 1 relating to the second modification example includes: the speed reducer 4 having: the speed reducing unit 45 configured to reduce the rotation input thereto; the first member 41 having the housing portion 48 housing the speed reducing unit 45, the first member 41 having the through hole 41b used to fixedly attach the housing portion 48 to the mounting member 47; the buffer portion 5 shaped like a tube, the buffer portion 5 covering the inner wall 41c of the through hole 41b, the buffer portion 5 having the first and second portions 51 and 52 with different degrees of deformability under a certain level of stress; and the bushing 6 provided inside the buffer portion 5, the bushing 6 being shaped like a tube; the mounting member 47 arranged next to the first member 41 with a gap in the radial direction DF perpendicular to the axis LB of the through hole 41b; and the bolt 7 passing through the bushing 6 to fixedly attach the housing portion 48 to the mounting member 47. In the second modification example, the width w8 of the gap between the first member 41 and the mounting member 47 in the radial direction DF is also greater than the width w9 of the gap between the bushing 6 and the bolt 7 in the radial direction DF.

In the construction machine 1 relating to the second modification example, as in the speed reducer 4 relating to the above-described embodiment, the width w8 is greater than the width w9. The mounting member 47 may experience an impact and accordingly move in the radial direction DF, but the bolt 7 can come into contact with the buffer portion 5 in the radial direction DF before the surface of the mounting member 47 comes in direct contact with the surface of the first member 41 in the radial direction DF.

### Third Modification Example

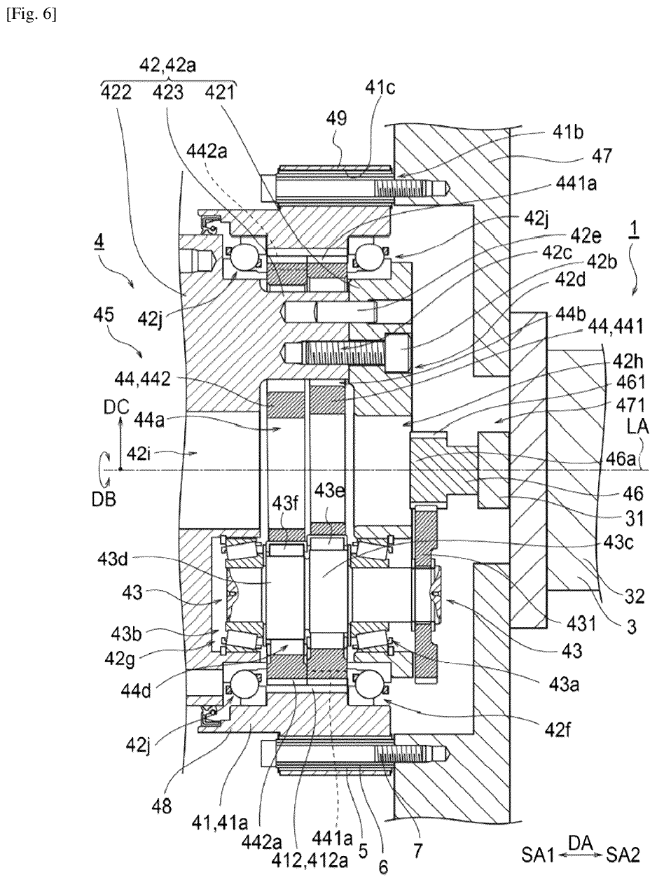

According to the embodiment and modification examples described above, the transmission gears 431 are each fixedly attached to the end of the corresponding crankshaft 43 that faces the first side SA1 in the rotation axis direction DA. However, the speed reducer 4 may be configured in any other manners. FIG. 6 is a sectional view showing an example configuration of a construction machine 1 with a built-in speed reducer 4 relating to a third modification example, more specifically, a part surrounding the electric motor 3 and speed reducer 4. More specifically, FIG. 6 is a sectional view of the construction machine 1 along a plane passing through the rotation axis LA of the rotation output from the speed reducer 4.

According to the third modification example, the transmission gears 431 are each fixedly attached to the end of the corresponding crankshaft 43 that faces the second side SA2 in the rotation axis direction DA. The transmission gears 431 are positioned on the second side SA2 in the rotation axis direction DA with respect to the first and second external gears 441 and 442. The drive gear 461, which is provided at the end 46a of the input shaft 46, meshes with the transmission gears 431 on the second side SA2 in the rotation axis direction DA with respect to the first and second external gears 441 and 442.

In the construction machine 1 relating to the third modification example, the buffer portion 5 can also mitigate the impact transmitted to the speed reducer 4, specifically, the components of the speed reducer 4 such as the first member 41 and speed reducing unit 45. In addition, appropriate torque can be transmitted from the electric motor 3 to the speed reducer 4. Therefore, in the construction machine 1 relating to the third modification example, the speed reducer 4 can also reduce the rotation input from the electric motor 3 and output the reduced rotation.

### Fourth Modification Example

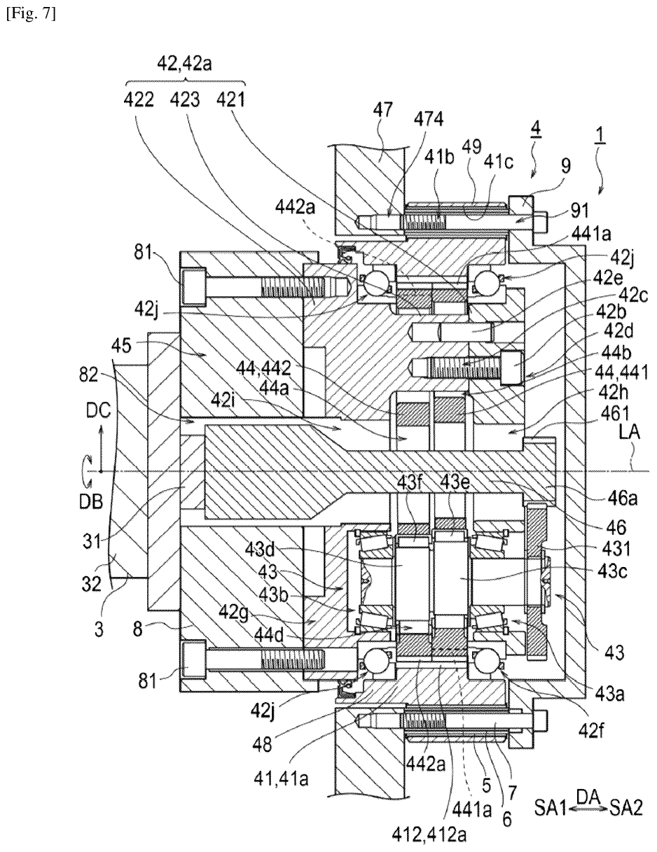

According to the embodiment and modification examples described above, the main body portion 32 of the electric motor 3 is fixedly attached to the mounting member 47. However, the electric motor 3 may be fixedly attached in any other manners. FIG. 7 is a sectional view showing an example configuration of a construction machine 1 with a built-in speed reducer 4 relating to a fourth modification example, more specifically, a part surrounding the electric motor 3 and speed reducer 4. More specifically, FIG. 7 is a sectional view of the construction machine 1 along a plane passing through the rotation axis LA of the rotation output from the speed reducer 4.

In the fourth modification example, the main body portion 32 of the electric motor 3 is fixedly attached to the second member 42. In FIG. 7, the construction machine 1 further includes a connecting member 8 connecting the electric motor 3 and the second member 42 of the speed reducer 4. The connecting member 8 is fixedly attached to the surface of the second member 42 that faces the first side SA1 by means of a bolt 81. The main body portion 32 of the electric motor 3 is fixedly attached to the surface of the connecting member 8 that faces the first side SA1 by means of a bolt, which is not shown. In this way, the main body portion 32 of the electric motor 3 is positioned on the first side SA1 with respect to the second member 42 and fixedly attached to the second member 42.

The connecting member 8 has a through hole 82 extending through the connecting member 8 in the rotation axis direction DA. The through hole 82 receives the rotating shaft 31 of the electric motor 3. The base end of the input shaft 46 of the speed reducer 4 that faces the electric motor 3 (faces the first side SA1 in the rotation axis direction DA) is coupled with the rotating shaft 31 of the electric motor 3 in the through hole 82.

As shown in FIG. 7, the transmission gears 431 are each fixedly attached to the end of the corresponding crankshaft 43 that faces the second side SA2 in the rotation axis direction DA. The transmission gears 431 are positioned on the second side SA2 in the rotation axis direction DA with respect to the first and second external gears 441 and 442. The input shaft 46 is inserted through the first through holes 44a in the first and second external gears 441 and 442, and the through hole 42h in the end plate portion 421. The drive gear 461, which is provided at the end 46a of the input shaft 46, thus meshes with the transmission gears 461 on the second side SA2 in the rotation axis direction DA with respect to the first and second external gears 441 and 442.

Referring to FIG. 7, the mounting member 47, to which the housing portion 48 is fixed, constitutes part of the construction machine 1. The mounting member 47 is partly positioned on the first side SA1 in the rotation axis direction DA with respect to the flange portion 49. Therefore, the flange portion 49 faces part of the mounting member 47. The part of the mounting member 47 that faces the flange portion 49 has a threaded hole 474 that extends in the rotation axis direction DA and that open toward the second side SA2. The speed reducer 4 further includes a fixation assisting member 9 that is located on the second side SA2 in the rotation axis direction DA with respect to the first member 41 of the speed reducer 4. The fixation assisting member 9 covers the speed reducing unit 45 and first member 41 entirely from the second side SA2 in the rotation axis direction DA. The fixation assisting member 9 is partly positioned on the second side SA2 in the rotation axis direction DA with respect to the flange portion 49. Therefore, the flange portion 49 faces part of the fixation assisting member 9. The part of the fixation assisting member 9 that faces the flange portion 49 has a through hole 91 that extends in the rotation axis direction DA through the fixation assisting member 9.

Referring to FIG. 7, the mounting member 47 and fixation assisting member 9 are fixedly attached to the housing portion 48 by means of the bolt 7. Specifically, as shown in FIG. 7, the bolt 7 is inserted into the through holes 91 and 41b and then tightened into the threaded hole 474. In this manner, the mounting member 47 and fixation assisting member 9 can be fixedly attached to the housing portion 48.

According to the fourth modification example, the speed reducer 4 also has the buffer portion 5 covering the inner wall 41c of the through hole 41b. The speed reducer 4 includes the bushing 6 provided inside the buffer portion 5. The bolt 7 passes through the buffer portion through hole 5a and also through the bushing through hole 6a.

According to the fourth modification example, the dimension w1 of the bushing 6 is also greater than the dimension w2 of the through hole 41b. According to the fourth modification example, the dimension w1 of the bushing 6 is also greater than the dimension w3 of the flange portion 49. As a result, the mounting member 47 is not in direct contact with the first member 41 in the rotation axis direction DA. In addition, the fixation assisting member 9 is not in direct contact with the first member 41 in the rotation axis direction DA.

In the construction machine 1 relating to the fourth modification example, the buffer portion 5 can also mitigate the impact transmitted to the speed reducer 4, specifically, the components of the speed reducer 4 such as the first member 41 and speed reducing unit 45. In addition, when the speed reducer 4 reduces the rotation input thereto from the electric motor 3 and outputs the reduced rotation, the speed reducer 4 can appropriately transmit the torque from the electric motor 3. Therefore, in the construction machine 1 relating to the fourth modification example, the speed reducer 4 can also reduce the rotation input from the electric motor 3 and output the reduced rotation.

### Fifth Modification Example

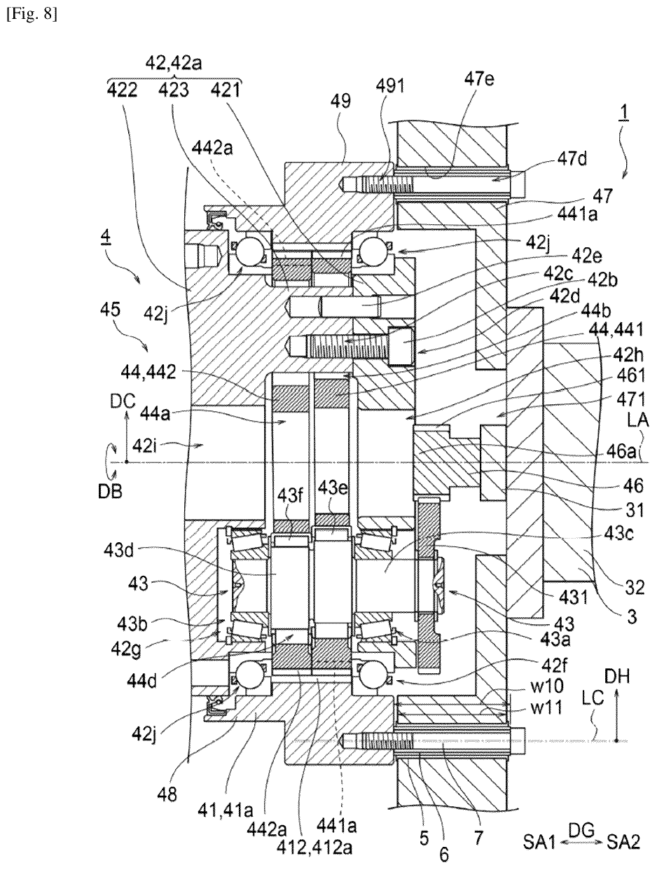

According to the embodiment and modification examples described above, the first member 41 has the through hole 41b used to fixedly attach the housing portion 48 to the mounting member 47. However, the speed reducer 4 and construction machine 1 may be configured in any other manners. FIG. 8 is a sectional view showing an example configuration of a construction machine 1 with a built-in speed reducer 4 relating to a fifth modification example, more specifically, a part surrounding the electric motor 3 and speed reducer 4. More specifically, FIG. 8 is a sectional view of the construction machine 1 along a plane passing through the rotation axis LA of the rotation output from the speed reducer 4.

In the fifth modification example, the first member 41 has no through hole 41b. Alternatively, the mounting member 47 has a through hole 47d used to fixedly attach the housing portion 48 to the mounting member 47. In this case, the mounting member 47 may be considered to constitute part of the speed reducer 4. The mounting member 47 may be a relatively large member of the construction machine 1, when compared to the first member 41 and speed reducing unit 45 of the speed reducer 4. Referring to FIG. 8, the mounting member 47 is considered to constitute part of the speed reducer 4.

The through hole 41b in the first member 41 is described in the forgoing embodiment and first to fourth modification examples. As long as they are consistent, the descriptions hold true for the through hole 47d in the mounting member 47 in the fifth modification example.

The speed reducer 4 shown in FIG. 8 further has a buffer portion 5 that is shaped like a tube and that covers the inner wall 47e of the through hole 47d. The buffer portion 5 has a first portion 51 and a second portion 52 with different degrees of deformability under a certain level of stress. The speed reducer 4 further includes a bushing 6. The bushing 6 is provided inside the buffer portion 5 and shaped like a tube. The buffer portion 5, bushing 6 and bolt 7 are described in the forgoing embodiment and first to fourth modification examples. As long as they are consistent, the descriptions hold true for the buffer portion 5, bushing 6 and bolt 7 in the fifth modification example.

In the fifth modification example, the part of the flange portion 49 that faces the mounting member 47 has a threaded hole 491 that extends in the rotation axis direction DA and that opens toward the second side SA2. In the fifth modification example, the bolt 7 is inserted through the through hole 47d and screwed into the threaded hole 491 in the flange portion 49, so that the first member 41 (the casing 41a) is fixedly attached to the mounting member 47 and the housing portion 48 is fixedly attached to the mounting member 47. The bolt 7 passes through the buffer portion through hole 5a and also through the bushing through hole 6a.

The dash-dot line identified by the label LC in FIG. 8 is an imaginary line indicating the axis LC of the through hole 47d. The direction in which the through hole 47d extends (the direction in which the axis LC of the through hole 47d extends) is also referred to as the axial direction DG. The term “radial direction DH” refers to the direction perpendicular to the axis LC of the through hole 47d. According to the fifth modification example, the dimension w10 of the bushing 6 in the axial direction DG in which the through hole 47d extends is greater than the dimension w11 of the through hole 47d in the axial direction DG. Therefore, the bushing 6 may protrude beyond the through hole 47d on both sides. As a result, the mounting member 47 is spaced away from the first member 41 in the axial direction DG. This prevents direct impact transmission from the mounting member 47 to the first member 41 in the axial direction DG.

Although not shown, the mounting member 47 of the fifth modification example may have a portion facing the first member 41 in the radial direction DH. In this case, the mounting member 47 can be arranged next to the first member 41 with a gap in the radial direction DH perpendicular to the axis LC of the through hole 47d. Specifically, the mounting member 47 is arranged such that the width of the gap between the first member 41 and the mounting member 47 in the radial direction DH is greater than the width of the gap between the bushing 6 and the bolt 7 in the radial direction DH. The buffer portion 5 can thus mitigate an impact before the surface of the mounting member 47 comes into direct contact with the surface of the first member 41 in the radial direction DH. If the surface of the mounting member 47 comes into direct contact with the surface of the first member 41 in the radial direction DH, a strong impact can be transmitted from the mounting member 47 to the first member 41. The fifth modification example can prevent this issue.

In the construction machine 1 relating to the fifth modification example, the buffer portion 5 can also mitigate the impact transmitted to the speed reducer 4, specifically, the components of the speed reducer 4 such as the first member 41 and speed reducing unit 45. In addition, appropriate torque can be transmitted from the electric motor 3 to the speed reducer 4. As a result, in the construction machine 1 relating to the fifth modification example, the speed reducer 4 can also reduce the rotation input thereto from the electric motor 3 and output the reduced rotation.

The foregoing embodiment disclosed herein describes a plurality of physically separate constituent parts. They may be combined into a single part, and any one of them may be divided into a plurality of physically separate constituent parts. Irrespective of whether or not the constituent parts are integrated, they are acceptable as long as they are configured to attain the object of the invention.

Aspects of the present invention are not limited to the foregoing embodiment and embrace various modifications conceivable by those skilled in the art. Advantageous effects of the invention are also not limited to those described above. In other words, various additions, modifications, and partial deletions are possible in a range not departing from the conceptual ideas and spirit of the present invention derived from contents defined in the claims and the equivalents thereof.

### REFERENCE SIGNS LIST

1 construction machine
2 drive machine
3 electric motor
31 rotating shaft
4 speed reducer
41 first member
41b through hole
42 second member
43 crankshaft
44 external gear
45 speed reducing unit
47 mounting member
48 housing portion
49 flange portion
5 buffer portion
51 first portion
52 second portion
6 bushing
7 bolt

1. A speed reducer comprising:
a speed reducing unit configured to reduce rotation input thereto;
a first member having a housing portion housing the speed reducing unit, the first member having a through hole used to fixedly attach the housing portion to a mounting member; and
a tubular buffer portion covering an inner wall of the through hole, the buffer portion having a first portion and a second portion with different degrees of deformability under a certain level of stress.

2. The speed reducer of claim 1, further comprising
a tubular bushing provided inside the buffer portion.

3. The speed reducer of claim 2, wherein a dimension of the bushing in an axial direction in which the through hole extends is greater than that of the through hole in the axial direction.

4. The speed reducer of claim 2,
wherein the first member further includes a flange portion protruding from the housing portion in a direction intersecting an axial direction in which the through hole extends, the flange portion facing the mounting member,
wherein the flange portion has the through hole, and
wherein a dimension of the bushing in the axial direction is greater than that of the flange portion in the axial direction.

5. The speed reducer of claim 2, further comprising
a bolt passing through the bushing to fixedly attach the housing portion to the mounting member,
wherein a dimension of the bushing in a radial direction perpendicular to an axis of the through hole is equal to or greater than a dimension of a head of the bolt in the radial direction.

6. The speed reducer of claim 1, further comprising
a second member rotatable relative to the first member,
wherein the first member has internal teeth, and
wherein the speed reducing unit has:
a crankshaft rotatably supported by the second member; and
an external gear having a through hole penetrated by the crankshaft, the external gear having external teeth meshing with the internal teeth of the first member.

7. The speed reducer of claim 2, further comprising:
the mounting member arranged next to the first member with a gap in a radial direction perpendicular to an axis of the through hole; and
a bolt passing through the bushing to fixedly attach the housing portion to the mounting member,
wherein a width of the gap between the first member and the mounting member in the radial direction is greater than that of a gap between the bolt and the bushing in the radial direction.

8. A speed reducer comprising:
a speed reducing unit configured to reduce rotation input thereto;
a first member having a housing portion housing the speed reducing unit;
a mounting member to which the housing portion is fixedly attached, the mounting member having a through hole used to fixedly attach the housing portion to the mounting member; and
a tubular buffer portion covering an inner wall of the through hole, the buffer portion having a first portion and a second portion with different degrees of deformability under a certain level of stress.

9. A construction machine including the speed reducer of claim 1.

10. A construction machine comprising:
the speed reducer of claim 1, the speed reducer further including a bushing provided inside the tubular buffer portion;
the mounting member arranged next to the first member with a gap in a radial direction perpendicular to an axis of the through hole; and
a bolt passing through the bushing to fixedly attach the housing portion to the mounting member,
wherein a width of the gap between the first member and the mounting member in the radial direction is greater than that of a gap between the bushing and the bolt in the radial direction.

11. A construction machine comprising:
a speed reducer including:
a speed reducing unit configured to reduce rotation input thereto; and
a first member having a housing portion housing the speed reducing unit;
a mounting member to which the housing portion is fixedly attached, the mounting member having a through hole used to fixedly attach the housing portion to the mounting member;
a tubular buffer portion covering an inner wall of the through hole, the buffer portion having a first portion and a second portion with different degrees of deformability under a certain level of stress;
a bushing provided inside the tubular buffer portion; and
a bolt passing through the bushing to fixedly attach the housing portion to the mounting member.

12. A construction machine including the speed reducer of claim 2.

13. A construction machine including the speed reducer of claim 3.

14. A construction machine including the speed reducer of claim 4.

15. A construction machine including the speed reducer of claim 5.

16. A construction machine including the speed reducer of claim 6.

17. A construction machine including the speed reducer of claim 7.

18. A construction machine including the speed reducer of claim 8.
